(19) United States
(12) Patent Application Publication
(10) Pub. No.: US 2023/0214183 A1
(43) Pub. Date: Jul. 6, 2023

(54) CARRY-LOOKAHEAD ADDER, SECURE ADDER AND METHOD FOR PERFORMING CARRY-LOOKAHEAD ADDITION

(71) Applicant: Nuvoton Technology Corporation, Hsinchu Science Park (TW)

(72) Inventors: Kun-Yi WU, Tainan City (TW); Yu-Shan LI, Tainan City (TW)

(21) Appl. No.: 18/089,762

(22) Filed: Dec. 28, 2022

(30) Foreign Application Priority Data
Dec. 30, 2021 (TW) 110149574

(51) Int. Cl. G06F 7/508; G06F 7/58

(52) U.S. Cl. CPC G06F 7/508; G06F 7/588

(57) ABSTRACT

A carry-lookahead adder is provided. First XOR gate receives a first mask value and a second mask value to provide a variable. First mask unit performs a first mask operation on first input data with the variable to obtain first masked data. A half adder receives the first masked data and second input data to generate a propagation value and an intermediate generation value. Second mask unit performs a second mask operation on the propagation value with a third mask value to obtain second masked data. A logic circuit provides a generation value according to the propagation value, the intermediate generation value and the second mask value. A carry-lookahead generator provides a carry output and a carry value according to a carry input, the generation value and the propagation value. Second XOR gate receives the second masked data and the carry value to provide a sum output.

### CROSS REFERENCE TO RELATED APPLICATIONS

This application claims priority of Taiwan Patent Application No. 110149574, filed on Dec. 30, 2021, the entirety of which is incorporated by reference herein.

### BACKGROUND OF THE INVENTION

### Field of the Invention

The invention relates to a secure adder, and more particularly to a secure carry-lookahead adder (SCLA).

### Description of the Related Art

Addition is an important function of many operations, so adders are widely used in various applications, such as signal processing, data protection, and so on. In recent years, encryption and decryption applications have attached great importance to protect confidential information, to prevent data from being stolen and analyzed. In general, a common and effective protection mechanism is exclusion (or mask) technology, which utilizes random numbers and important data (or variables) in an encryption and decryption algorithm to perform an exclusive-OR (XOR) operation to complete the mask protection mechanism. Therefore, encryption and decryption applications need a secure adder that can perform secure addition operations.

A secure addition operation requires a secure adder that can complete the addition operation without removing the mask of input data and revealing the original value of the input data during the calculation process, to provide the outputs protected by mask values. Secure adders that can perform secure addition operations are widely used in various integrated circuits (ICs) and in electronic products used in encryption and decryption applications.

Therefore, a secure adder with low manufacturing cost is desirable.

### BRIEF SUMMARY OF THE INVENTION

A carry-lookahead adder, a secure adder, and a method for performing carry-lookahead addition are provided. An embodiment of a carry-lookahead adder is provided. The carry-lookahead adder includes a first exclusive-OR (XOR) gate, a first mask unit, a half adder, a second mask unit, a logic circuit, a carry-lookahead generator, and a second XOR gate. The first XOR gate is configured to receive a first mask value and a second mask value, to provide a variable. The first mask unit is configured to perform a first mask operation on first input data corresponding to the first mask value with the variable, to obtain first masked data. The half adder is configured to receive the first masked data and second input data corresponding to the second mask value, to generate a propagation value and an intermediate generation value. The second mask unit is configured to perform a second mask operation on the propagation value with a third mask value, to obtain second masked data. The logic circuit is configured to provide a generation value according to the propagation value, the intermediate generation value and the second mask value. The carry-lookahead generator is configured to provide a carry output and a carry value according to the carry input, the generation value and the propagation value. The second XOR gate is configured to receive the second masked data and the carry value, to provide a sum output.

Moreover, an embodiment of a secure adder is provided. The secure adder includes a mask generator and a carry-lookahead adder. The mask generator includes a random number generator, and a first mask unit. The random number generator is configured to randomly generate a first mask value, a second mask value and a third mask value. The first mask unit is configured to perform a first mask operation on first data with the first mask value to obtain first masked data, and to perform a second mask operation on second data with the second mask value to obtain second masked data.

The carry-lookahead adder includes a first exclusive-OR (XOR) gate, a second mask unit, a half adder, a third mask unit, a logic circuit, a carry-lookahead generator, and a second XOR gate. The first XOR gate is configured to receive the first mask value and the second mask value, to provide a variable. The second mask unit is configured to perform a third mask operation on the first masked data with the variable, to obtain third masked data. The half adder is configured to receive the third masked data and the second masked data, to generate a propagation value and an intermediate generation value. The third mask unit is configured to perform a fourth mask operation on the propagation value with the third mask value, to obtain fourth masked data. The logic circuit is configured to provide a generation value according to the propagation value, the intermediate generation value and the second mask value. The carry-lookahead generator is configured to provide a carry output and a carry value according to the carry input, the generation value and the propagation value. The second XOR gate is configured to receive the fourth masked data and the carry value, to provide a sum output.

Furthermore, an embodiment of a method for performing carry-lookahead addition is provided. A variable is obtained according to a first mask value and a second mask value. A first mask operation is performed on first input data corresponding to the first mask value with the variable, to obtain first masked data. A half adder is used to obtain an intermediate generation value and a propagation value according to the first masked data and second input data corresponding to the second mask value. A second mask operation is performed on the propagation value with a third mask value, to obtain second masked data. A generation value is provided according to the propagation value, the intermediate generation value and the second mask value. A carry-lookahead generator is used to obtain a carry output and a carry value according to the carry input, the generation value and the propagation value. A sum output is obtained according to the second masked data and the carry value. The first mask operation and the second mask operation are performed by different exclusive-OR (XOR) gates.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a secure adder according to some embodiments of the invention.

FIG. 2 shows a method of performing carry-lookahead addition for the secure carry-lookahead adder of FIG. 1 according to some embodiments of the invention.

FIG. 3A shows an exemplary circuit of the secure carry-lookahead adder of the first type according to some embodiments of the invention.

FIG. 3B shows an exemplary circuit of the secure carry-lookahead adder of the second type according to some embodiments of the invention.

FIG. 4 shows a 4-bit carry-lookahead generator illustrating the carry-lookahead generator of FIGS. 3A and 3B according to some embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

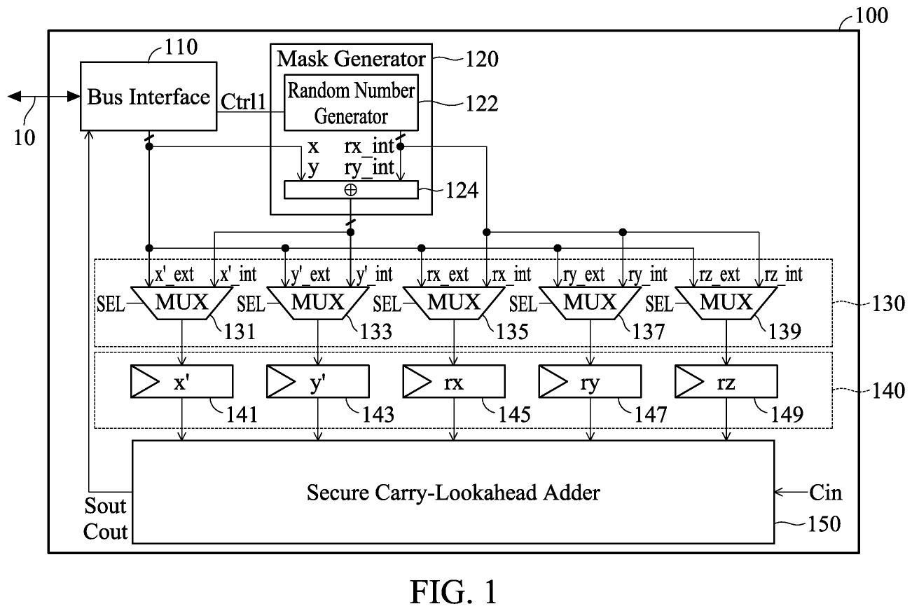

FIG. 1 shows a secure adder 100 according to some embodiments of the invention. The secure adder 100 may be implemented in an integrated circuit (IC) (not shown). In addition, the secure adder 100 can complete the addition operation without leaking operands, and provide mask protection for the output result. In some embodiments, the secure adder 100 is configured to perform data transfer via the bus 10 and other circuits (not shown) within the IC. For example, a processor (not shown) may provide a plurality of input data (or operands) to the secure adder 100 via the bus 10 to perform the addition operations. In some embodiments, the input data may be unmasked raw data. In some embodiments, the input data may be masked data. Furthermore, after completing the addition operations, the secure adder 100 is configured to provide the masked operation result to the processor via the bus 10.

In FIG. 1, the secure adder 100 includes a bus interface 110, a mask generator 120, a selection circuit 130, a storage circuit 140 and a secure carry-lookahead adder (SCLA) 150. The bus interface 110 is coupled to the bus 10 and configured to provide various input data (e.g., operands, mask values, control signals, etc.) from the bus 10 to the mask generator 120, the selection circuit 130 and the secure carry-lookahead adder 150. Moreover, after the addition operation is completed, the bus interface 110 is configured to provide output data (e.g., operation results) from the secure carry-lookahead adder 150 to the bus 10.

The mask generator 120 includes a random number generator (RNG) 122 and a mask unit 124. According to the control signal Ctr11 from the bus interface 110, the random number generator 122 is configured to generate a plurality of random numbers as the mask values rx_int, ry_int and rz_int. In some embodiments, the mask value rx_int is different from the mask value ry_int. In some embodiments, the mask value rx_int is equal to the mask value ry_int. The random number generator 122 is configured to provide the mask values rx_int and ry_int to the mask unit 124 and to provide the mask values rx_int, ry_int and rz_int to the selection circuit 130. In some embodiments, the control signal Ctr11 is provided by an external circuit (i.e., other circuits in the IC) via the bus 10. In some embodiments, the bus interface 110 is configured to generate the control signal Ctr11 to the mask generator 120 according to the input data from the bus 10. In addition, the mask unit 124 is configured to perform mask operations on the data x and the data y according to the mask value rx_int and the mask value ry_int, respectively, so as to obtain the masked data x′_int and the masked data y′_int. In general, the mask operation means to perform an exclusive-OR (XOR) operation between multi-bit data and multi-bit mask value, so as to mask out a portion of the bits in the data and provide the masked data, thereby preventing from being stolen. Furthermore, the mask unit 124 is configured to further provide the masked data x′_int and the masked data y′_int to the selection circuit 130. In addition, the data x and the data y are provided by the external circuit via the bus 10.

The selection circuit 130 includes multiplexers (MUX) 131, 133, 135, 137 and 139. In such embodiments, the multiplexers 131, 133, 135, 137 and 139 are controlled by the same selection signal SEL. In some embodiments, the selection signal SEL is provided by an external circuit via the bus 10. In some embodiments, the bus interface 110 is configured to generate the selection signal SEL to the selection circuit 130 according to the input data from the bus 10. When the selection signal SEL has a first logic level, the selection signal SEL is configured to control the multiplexers 131, 133, 135, 137 and 139 to provide the masked data x′_ext and y′_ext and the mask values rx_ext, Ty_ext and rz_ext from the bus interface 110 to the storage circuit 140, and then stored in the corresponding registers (or memory). The mask values rx_ext, ry_ext and rz_ext and the masked data x′_ext and y′_ext are provided by the external circuit via the bus 10. On the other hand, when the selection signal SEL has a second logic level, the selection signal SEL is configured to control the multiplexers 131, 133, 135, 137 and 139 to provide the masked data x′ int and y′_int and the mask values rx_int, Ty_int and rz_int from the mask generator 120 to the storage circuit 140, and then stored in the corresponding registers (or storage devices).

For the secure adder 100, the masked data x′ int and y′_int and the mask values rx_int, ry_int and rz_int are generated by the mask generator 120. As described above, the generation of the masked data x′_int is related to the mask value rx_int, and the generation of the masked data y′_int is related to the mask value ry_int. On the other hand, for the secure adder 100, the masked data x′_ext and y′_ext and the masked values rx_ext, ry_ext and rz_ext are provided by the external circuits. In addition, the generation of the masked data x′_ext is related to the mask value rx_ext, and the generation of the masked data y′_ext is related to the mask value ry_ext. In some embodiments, the mask value rx_ext is different from the mask value ry_ext. In some embodiments, the mask value rx_ext is equal to the mask value ry_ext.

The storage circuit 140 includes the registers 141, 143, 145, 147 and 149. The register 141 is configured to store the masked data x′_int or the masked data x′_ext from the multiplexer 131 as the input data x′ of the secure carry-lookahead adder 150. In addition, the register 143 is configured to store the masked data y′_int or the masked data y′_ext from the multiplexer 133 as the input data y′ of the secure carry-lookahead adder 150. For the secure carry-lookahead adder 150, the input data x′ and the input data y′ are masked data. Furthermore, the register 145 is configured to store the mask value rx_int or the mask value rx_ext from the multiplexer 135 as the mask value rx of the secure carry-lookahead adder 150. The register 147 is configured to store the mask value ry_int or the mask value ry_ext from the multiplexer 137 as the mask value ry of the secure carry-lookahead adder 150. The register 149 is configured to store the mask value rz_int or the mask value rz_ext from the multiplexer 139 as the mask value rz of the secure carry-lookahead adder 150. Next, the secure carry-lookahead adder 150 is configured to generate a carry output Cout and a sum output Sout according to the input data x′ and y′, the mask values rz, ry and rz, and the carry input Cin from the storage circuit 140.

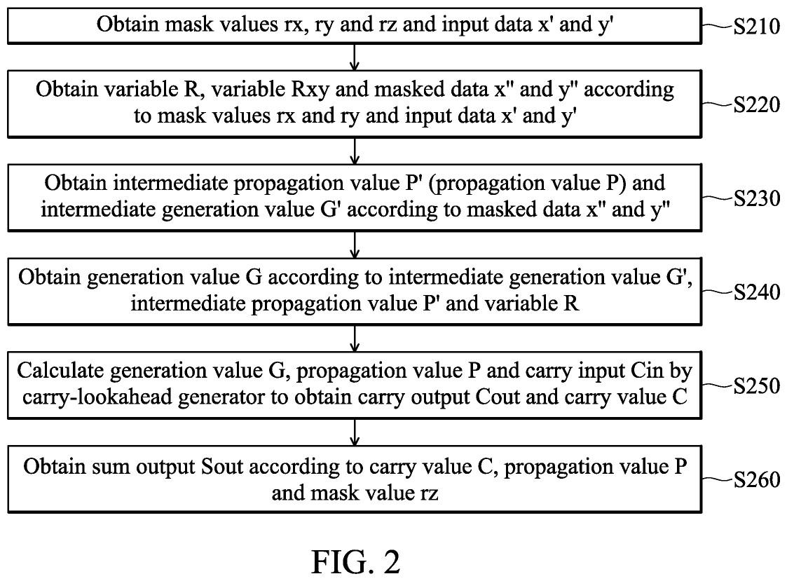

FIG. 2 shows a method of performing carry-lookahead addition for the secure carry-lookahead adder 150 of FIG. 1 according to some embodiments of the invention. In some embodiments, the method of FIG. 2 for performing the carry-lookahead addition may be performed by other circuits (e.g., a processor).

First, in step S210, the mask values rx, ry and rz and the input data x′ and y′ are obtained. As described above, the input data x′ is obtained by performing a mask operation (e.g., XOR operation “⊕”) on the data x with the mask value rx, as shown in the following equation (1):

x′=x⊕rx (1).

Similarly, the input data y′ is obtained by performing a mask operation (e.g., XOR operation) on the data y with the mask value ry, as shown in the following equation (2):

=y′=y⊕ry (2).

Furthermore, the mask value rz is used to perform a mask operation on the result of the carry-lookahead addition operation, so as to provide security protection for the output, which will be described in detail later.

In step S220, the variable Rxy is obtained according to the mask value rx and the mask value ry, as shown in the following equation (3):

Rxy=rx⊕ry (3).

Next, according to the mask value rx or the mask value ry, a variable R is obtained. The following description will be divided into a first type and a second type.

In the first type, the variable R is equal to the mask value rx, as shown in the following equation (4):

R=rx (4).

Furthermore, according to the input data x′, the masked data x″ is obtained, and a mask operation is performed on the input data y′ with the variable R, so as to obtain the masked data y″, that are shown in the following equations (5) and (6) respectively:

x″=x′ (5); and

y″=y′⊕Rxy (6).

According to the equations (1) and (4), equation (5), the masked data x″ is obtained by performing an XOR operation on the data x and the variable R, as shown in the following equation (7):

x″=x′=x⊕rx=x⊕R (7).

Furthermore, if the mask value ry is different from the mask value rx (i.e., ry≢rx), according to the equations (2), (3) and (6), the masked data y″ is obtained by performing an XOR operation on the data y and the variable Rxy, as shown in the following equation (8):

y″=y′⊕Rxy=(y⊕ry)⊕(rx⊕ry)

=y⊕rx⊕(ry⊕ry)=y⊕R (8).

Conversely, if the mask value ry is the same as the mask value rx (i.e., ry=rx), the variable Rxy is equal to 0. Therefore, according to equations (2) and (6), the mask value ry that is the same as the mask value rx and the variable R that is also equal to the mask value rx, the masked data y″ is obtained by performing an XOR operation on the data y and the variable R, as shown in the following equation (9):

y″=y′⊕Rxy=y′⊕0=y′

=y⊕ry=y⊕rx=y⊕R (9).

From the equations (7), (8) and (9), it can be known that regardless of whether the mask value ry is the same as the mask value rx, the masked data y′ is obtained by performing an XOR operation on the data y and the variable R. In addition, the original values of the data x and the data y will not be revealed during the operation of the equation (3) to the equation (6). In other words, it is not necessary to limit the mask value ry and the mask value rx when using the security adder 100 to perform the addition operation. For example, in the conventional security adder, the mask value ry needs to be restricted from being different from the mask value rx.

In the second type, the variable R is equal to the mask value ry, as shown in the following equation (10):

R=ry (10).

In addition, performing a mask operation on the input data x′ according to the variable Rxy, the masked data x″ can be obtained, and the masked data y″ is obtained according to the input data y′, as shown in the following equations (11) and equation (12):

x″=x′⊕Rxy (11); and

y″=y′=y⊕ry=y⊕R (12).

According to the equations (2), (10) and (12), the masked data y″ is obtained by performing an XOR operation on the data y and the variable R, as shown in the following equation (13):

y″=y′=y⊕ry=y⊕R (13).

Furthermore, if the mask value ry is different from the mask value rx (i.e., ry rx), according to the equations (1), (3) and (11), the masked data x″ is obtained by performing an XOR operation equal on the data x and the variable Rxy, as shown in the following equation (14):

$${x}^{″} = {x}^{′} ⊕ Rxy = ( x ⊕ rx ) ⊕ ( rx ⊕ ry ) = x ⊕ ry ⊕ ( rx ⊕ rx ) = x ⊕ R . \qquad ( 14 )$$

Conversely, if the mask value ry is the same as the mask value rx (i.e., ry=rx), the variable Rxy is equal to 0. Therefore, according to the equations (2) and (11), the mask value ry that is the same as the mask value rx, and the variable R that is also equal to the mask value ry, the masked data x″ is obtained by performing an XOR operation on the data x and the variable R, as shown in the following equation (15):

$${x}^{″} = {x}^{′} ⊕ Rxy = {x}^{′} ⊕ 0 = {x}^{′} \\ = x ⊕ rx = x ⊕ ry = x ⊕ R . \qquad ( 15 )$$

From the equations (13), (14) and (15), it can be known that regardless of whether the mask value ry is the same as the mask value rx, the masked data y′ is obtained by performing an XOR operation on the data y and the variable R. In addition, the original values of the data x and the data y will not be revealed during the operation of the equation (3) and the equations (10)-(12). In other words, it is not necessary to limit the mask value ry and the mask value rx when using the security adder 100 to perform the addition operation. For example, in the conventional security adder, the mask value ry needs to be restricted from being different from the mask value rx.

In step S230, according to the masked data x″ and the masked data y″ obtained in the first type or the second type, an intermediate propagation value P′ is obtained, as shown in the following equation (16):

P′=x″⊕y″ (16).

Next, according to the equations (7) through (9) of the first type or the equations (13) through (15) of the second type, it is obtained that the intermediate propagation value P′ (i.e., x″⊕y″) of the equation (16) is equal to the propagation value P (i.e., x⊕y), as shown in the following equation (17):

$${P}^{′} = {x}^{″} ⊕ {y}^{″} = ( x ⊕ R ) ⊕ ( y ⊕ R ) = x ⊕ y = P . \qquad ( 17 )$$

In addition, the intermediate generation value G′ is obtained by performing an AND operation (“&”) on the masked data x″ and the masked data y″, as shown in the following equation (18):

G′=x″&y″ (18).

In step S240, according to the distributive property between the AND operation and the XOR operation (e.g., (a⊕b)&c=(a&c)⊕(b&c)), the AND operation of the equation (18) is assigned to the lowest-level operation, as shown in the following equation (19):

$$\begin{matrix}{G}^{′} = {x}^{″} \& {y}^{″} = ( x ⊕ R ) \& ( y ⊕ R ) \\ = ( x \& ( y ⊕ R ) ) ⊕ ( R \& ( y ⊕ R ) ) \\ = ( x \& y ) ⊕ ( x \& R ) ⊕ ( R \& y ) ⊕ ( R \& R ) \\ = ( x \& y ) ⊕ ( x \& R ) ⊕ ( R \& y ) ⊕ R\end{matrix} . \qquad ( 19 )$$

Next, for the adder, the AND operation is performed on the data x and the data y to obtain the generation value G, i.e., G=x&y. Thus, the equation (19) can be rewritten as the equation (20), as shown below:

$$\begin{matrix}{G}^{′} = ( x \& y ) ⊕ ( x \& R ) ⊕ ( R \& y ) ⊕ R \\ = G ⊕ ( x \& R ) ⊕ ( y \& R ) ⊕ R\end{matrix} . \qquad ( 20 )$$

Next, according to the distributive property between AND operation and XOR operation, the equation (20) can be rewritten as the equation (21), as shown below:

$$\begin{matrix}{G}^{′} = G ⊕ ( x \& R ) ⊕ ( y \& R ) ⊕ R \\ = G ⊕ ( ( x ⊕ y ) \& R ) ⊕ R\end{matrix} . \qquad ( 21 )$$

Next, the equation (17) is substituted into the equation (21) to obtain the equation (22), as shown below:

G′=G⊕(P′&R)⊕R (22).

Next, according to the associative property of the XOR operation and the equation (22), the generation value G is obtained according to the equation (23), as shown below:

G=G′⊕(P′&R)⊕R (23).

In step S250, according to the propagation value P obtained in the equation (17), the generation value G obtained in the equation (23) and the carry input Cin, the carry-lookahead generator is configured to obtain the carry output Cout and the carry value C. The carry-lookahead generator will be described later. In some embodiments, the initial value of the carry input Cin is zero. In some embodiments, the carry input Cin is provided by an external circuit via the bus 10.

In step S260, according to the operation principle of the adder, an XOR operation is performed on the data x, the data y and the carry value C to obtain the sum output Sout, as shown in the following equation (24):

$$\begin{matrix}Sout = ( x + y ) = x ⊕ y ⊕ C \\ = {P}^{′} ⊕ C\end{matrix} . \qquad ( 24 )$$

Next, an XOR operation is performed on the sum output Sout and the mask value rz, so as to satisfy the condition that all the input values and the output values have be masked in the addition operations. Thus, the masked sum output Sout is obtained, as shown in the following equation (25):

Sout=(P′⊕rz)⊕C (25).

In general, the carry-lookahead generator can obtain the carry input Cout and the carry value C according to the propagation value P, the generation value G and the carry input Cin, as shown in the following equation (26):

{Cout,C}=CLG(G,P,Cin) (26),

where CLG is a function of the carry-lookahead generator. Therefore, the equation (27) is obtained by substituting the carry value C of the equation (26) into the equation (25), as shown below:

Sout=(P′⊕rz)⊕CLG(G,P,Cin) (27).

Next, substituting the generated value G of the equation (23) into the equation (27) can obtain the equation (28), as shown below:

$$\begin{matrix}Sout = ( {P}^{′} ⊕ rz ) ⊕ CLG ( G , P , Cin ) \\ = ( {P}^{′} ⊕ rz ) ⊕ CLG ( {G}^{′} ⊕ ( {P}^{′} \& R ) ⊕ R , P , Cin )\end{matrix} . \qquad ( 28 )$$

Next, substituting the propagation value P and the intermediate propagation value P′ of the equation (17) into the equation (28) can obtain the equation (29), as shown below:

$$Sout = ( {P}^{′} ⊕ rz ) ⊕ CLG ( {G}^{′} ⊕ ( {P}^{′} \& R ) ⊕ R , P , Cin ) \qquad ( 29 )$$

$$= ( ( {x}^{″} ⊕ {y}^{″} ) ⊕ rz ) ⊕ CLG ( {G}^{′} ⊕ ( ( {x}^{″} ⊕ {y}^{″} ) \& R ) ⊕ R , ( {x}^{″} ⊕ {y}^{″} ) , Cin ) .$$

Next, substitute the intermediate generated value G′ of the equation (18) into the equation (29) to obtain the equation (30), as shown below:

$$Sout = ( {x}^{″} ⊕ {y}^{″} ⊕ rz ) ⊕ CLG ( ( ( {x}^{″} ⊕ {y}^{″} ) ⊕ ( ( {x}^{″} ⊕ {y}^{″} ) \& R ) ⊕ R ) , ( {x}^{″} ⊕ {y}^{″} ) , Cin ) \qquad ( 30 )$$

$$= ( {x}^{″} ⊕ {y}^{″} ⊕ rz ) ⊕ CLG ( ( ( {x}^{″} \& {y}^{″} ) ⊕ R ⊕ ( ( {x}^{″} ⊕ {y}^{″} ) \& R ) ) , ( {x}^{″} ⊕ {y}^{″} ) , Cin ) .$$

Therefore, the logic circuit of the safe carry-lookahead adder 150 is obtained according to the equation (30), the equation (3) and the equation (7) through equation (9) of the first type or the equation (13) through equation (15) of the second type.

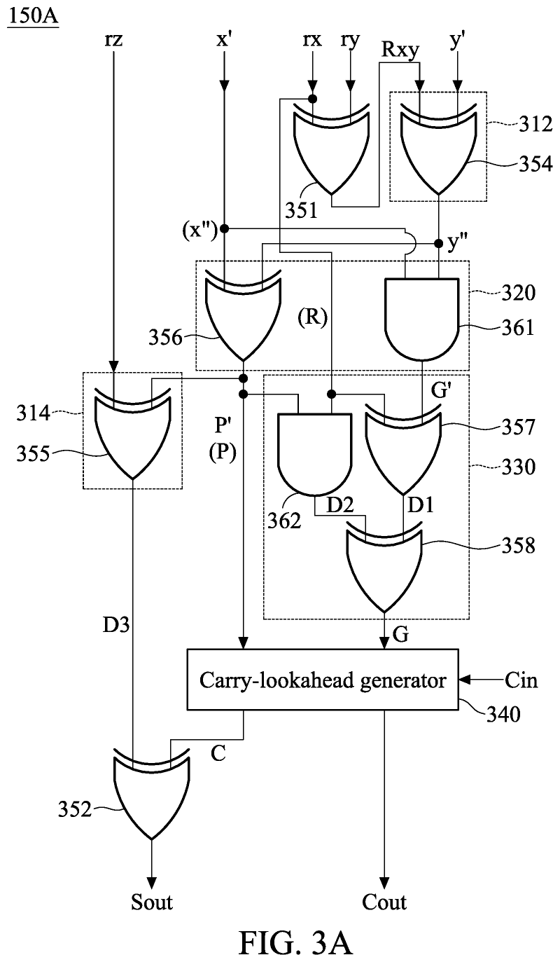

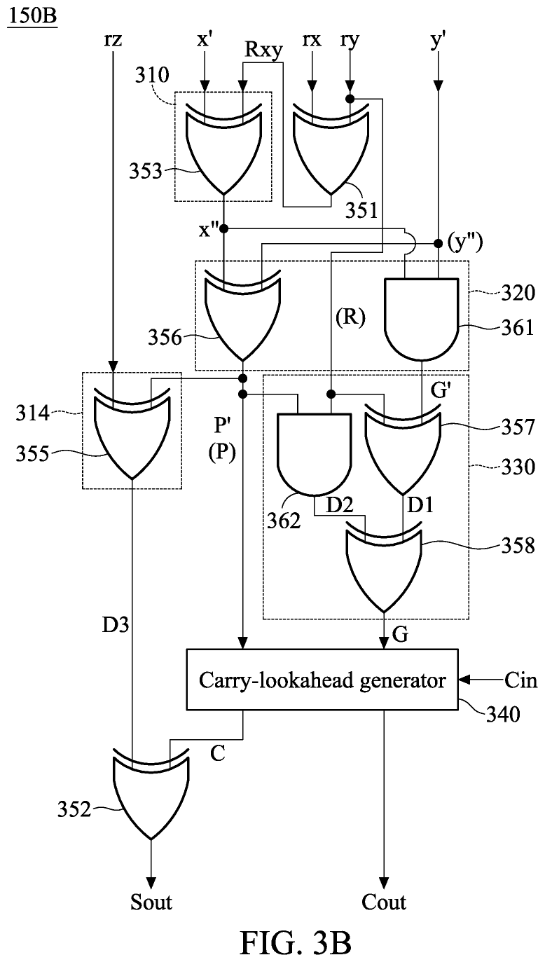

FIG. 3A shows an exemplary circuit of the secure carry-lookahead adder 150A of the first type according to some embodiments of the invention. The secure carry-lookahead adder 150A includes the mask units 312 and 314, a half adder 320, a logic circuit 330, a carry-lookahead generator 340, and the XOR gates 351 and 352.

As shown in the equation (5), the masked data x″ is equal to the input data x′. The XOR gate 351 is configured to perform an XOR operation on the mask value rx with the mask value ry, so as to obtain the variable Rxy, as shown in the equation (2). In addition, the mask unit 312 includes an XOR gate 354, which is configured to perform a mask operation (i.e., XOR operation) on the input data y′ with the variable Rxy, so as to obtain the masked data y″, as shown in the equation (6).

The half adder 320 includes the XOR gate 356 and the AND gate 361. The XOR gate 356 is configured to receive the masked data x″ and the masked data y″, and output the intermediate propagation value P′, as shown in the equation (17). As previously described, the intermediate propagation value P′ (i.e., x″⊕y″) is equal to the propagation value P (i.e., x⊕y). Moreover, the AND gate 361 is configured to receive the masked data x″ and the masked data y″, and output an intermediate generation value G′, as shown in the equation (18).

The logic circuit 330 is configured to provide the generation value G according to the variable value R, the intermediate generation value G′, and the intermediate propagation value P′ (i.e., the propagation value P). In some embodiments, logic circuit 330 includes the XOR gate 357, the XOR gate 358, and the AND gate 362. The XOR gate 357 is configured to receive the variable R and the intermediate generation value G′, and output the intermediate data D1. The AND gate 362 is configured to receive the variable R and the intermediation propagation value P′ (i.e., the propagation value P), and output the intermediate data D2. Additionally, the XOR gate 358 is configured to receive the intermediate data D1 and D2 and output the generation value G to the carry-lookahead generator 340. Thus, the carry-lookahead generator 340 is configured to obtain the carry output Cout and the carry value C according to the propagation value P (i.e., the intermediate propagation value P′), the generation value G, and the carry input Cin. The operation of the carry-lookahead generator 340 will be described later.

The mask unit 314 includes an XOR gate 355 that is configured to perform a mask operation on the intermediate propagation value P′ (i.e., the propagation value P) with the mask value rz, so as to obtain the masked data D3. It should be noted that due to longer delay in the delivery path within the carry-lookahead generator 340, the mask value rz is used to perform a mask operation on the intermediate propagation value P′ through the mask unit 314. Next, the XOR gate 352 is configured to receive the masked data D3 and the carry value C and provide the sum output Sout.

After obtaining the sum output Sout, the safe carry-lookahead adder 150A is configured to provide the sum output Sout and the carry output Cout to the bus interface 110, so as to provide to other circuits (e.g., processors) via the bus 10 for subsequent operations. As described above, the sum output Sout is the masked data. Therefore, in addition to providing the sum output Sout and the carry output Cout, the secure adder 100 is configured to further provide the mask value rz to other circuits. Therefore, other circuits can use the mask value rz to remove the mask of the sum output S out, so as to obtain the original value of the sum output Sout.

FIG. 3B shows an exemplary circuit of the secure carry-lookahead adder 150B of the second type according to some embodiments of the invention. The secure carry-lookahead adder 150B includes the mask units 310 and 314, a half adder 320, a logic circuit 330, a carry-lookahead generator 340, and the XOR gates 351 and 352.

In FIG. 3B, the masked data y″ is equal to the input data y′, as shown in the equation (12). In addition, the mask unit 310 includes an XOR gate 353 configured to perform a mask operation (i.e., an XOR operation) on the input data x′ according to the variable Rxy, so as to obtain the masked data x″, as shown in the equation (11).

Similar to FIG. 3A, the half adder 320 is configured to output an intermediate propagation value P′ (the propagation value P) and an intermediate generated value G′ according to the masked data x″ and the masked data y″. Next, the logic circuit 330 is configured to output the generated value G according to the variable R, the intermediate generated value G′ and the intermediate propagation value P′. Next, the carry-lookahead generator 340 is configured to obtain a carry output Cout and a carry value C according to the propagation value P (i.e., the intermediate propagation value P′), the generated value G, and the carry input Cin. As previously described, the XOR gate 352 is configured to receive carry value C and masked data D3 from the mask unit 314, and provide a sum output Sout.

After obtaining the sum output Sout, the secure carry-lookahead adder 150B is configured to provide the sum output Sout and the carry output Cout to the bus interface 110, so as to provide to other circuits (such as processors) via the bus 10 for subsequent operations. As previously described, the sum output Sout is the masked data. Therefore, in addition to providing the sum output Sout and the carry output Cout, the secure adder 100 is configured to further provide the mask value rz to other circuits. Thus, other circuits can use the mask value rz to remove the mask of the sum output Sout to obtain the original value of the sum output Sout.

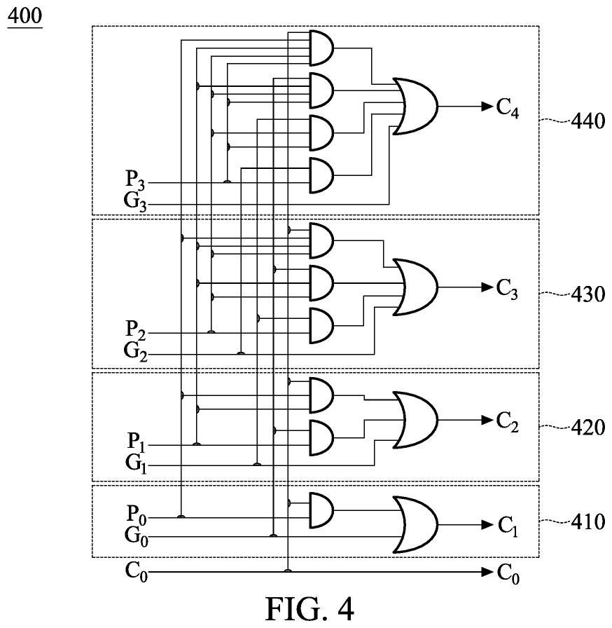

FIG. 4 shows a 4-bit carry-lookahead generator 400 illustrating the carry-lookahead generator 340 of FIGS. 3A and 3B according to some embodiments of the invention. In such embodiments, the propagation value P is 4-bit data consisting of the propagation signals (or bits) P₃, P₂, P₁ and P₀, i.e., P=[₃, P₂, P₁, P₀], where P₃ is the most significant bit (MSB) and P₀ is the least significant bit (LSB). The generation value G is 4-bit data consisting of the generation signals (or bits) G₃, G₂, G₁ and G₀, i.e., G=[G₃, G₂, G₁, G₀], where G₃ is the most significant bit and G₀ is the least significant bit. In addition, the input signal (or bit) C₀ is 1-bit data composed of the carry input Cin, i.e., C₀=Cin. According to the propagation value P, the generation value G, and the carry input Cin, the carry-lookahead generator 400 is configured to perform the operations of equations (31) to (34) to obtain the carry output Cout and the carry value C. The carry value C is 4-bit data composed of output signals (or bits) C₃, C₂, C₁ and C₀, i.e., C=[C₃, C₂, C₁, C₀], where C₃ is the most significant bit and C₀ is the least significant bit. In addition, the carry output Cout is determined by the output signal (or bit) C₄, i.e., Cout=C₄. Equations (31) to (34) are shown below:

C₁=G₀|P₀&C₀ (31);

C₂=G₁|P₁&G₀|P₁&P₀&C₀ (32);

C₃=G₂|P₂&G₁|P₂&P₁&G₀|P₂&P₁&P₀&C₀ (33); and

C₄=G₃|P₃&G₂|P₃&P₂&G₁|P₃&P₂&P₁&G₀|P₃&P₂&P₁P₀&C₀ (34).

As described above, “|” means to perform an OR operation, and “&” means to perform an AND operation.

The carry-lookahead generator 400 includes the logic circuits 410, 420, 430, and 440. The logic circuit 410 is configured to perform the operation of equation (31) to generate the signal C₁ according to the signal C₀, the signal G₀ and the signal P₀. The logic circuit 420 is configured to perform the operation of equation (32) to generate the signal C₂ according to the signal C₀, the signals G₀ and G₁, and the signals P₀ and P₁. Furthermore, the logic circuit 430 is configured to perform the operation of equation (33) to generate the signal C₃ according to the signal C₀, the signals G₀ through G₂, and the signals P₀ through P₂. The logic circuit 440 is configured to perform the operation of equation (34) to generate the signal C₄ according to the signal C₀, the signals G₀ through G₃, and the signals P₀ through P₃. It should be noted that the 4-bit carry-lookahead generator 400 is only an example, and is not intended to limit the invention. More-bit or less-bit carry-lookahead generator can be used in the secure adder of the invention. Moreover, the number of bits of the carry value C generated by the carry-lookahead generator 400 is the same as the number of bits of the propagation value P and the generation value G, and the number of bits of the carry output Cout is one bit.

According to the embodiments, in the secure adder 100, the secure carry-lookahead adders 150 of the first type and second type each is configured to perform operations on masked input data, and provide mask protection for the operation results. Compared with the conventional ripple-carry adders that cannot perform secure operations, the secure carry-lookahead adders 150 of the first type and second type do not require to remove the mask of input data (i.e., the secure carry-lookahead adder 150 does not reveal the original value of the input data (or operands)), thus providing secure protection for the input signal. Moreover, the secure carry-lookahead adder 150 can use fewer logic units to complete the operation of equation (30), thereby reducing the power consumption of the secure adder and reducing the area of the IC. Thus, the manufacturing cost is decreased.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A carry-lookahead adder, comprising:
a first exclusive-OR (XOR) gate configured to receive a first mask value and a second mask value, to provide a variable;
a first mask unit configured to perform a first mask operation on first input data corresponding to the first mask value with the variable, to obtain first masked data;
a half adder configured to receive the first masked data and second input data corresponding to the second mask value, to generate a propagation value and an intermediate generation value;
a second mask unit configured to perform a second mask operation on the propagation value with a third mask value, to obtain second masked data;
a logic circuit configured to provide a generation value according to the propagation value, the intermediate generation value and the second mask value;
a carry-lookahead generator configured to provide a carry output and a carry value according to a carry input, the generation value and the propagation value; and
a second XOR gate configured to receive the second masked data and the carry value, to provide a sum output.

2. The carry-lookahead adder as claimed in claim 1, wherein the first mask unit comprises:
a third XOR gate configured to receive the variable and the first input data, to provide the first masked data.

3. The carry-lookahead adder as claimed in claim 1, wherein the second mask unit comprises:
a fourth XOR gate configured to receive the third mask value and the propagation value, to provide the second masked data.

4. The carry-lookahead adder as claimed in claim 1, wherein the half adder comprises:
a first AND gate configured to receive the first masked data and the second input data, to provide the intermediate generation value; and
a fifth XOR gate configured to receive the first masked data and the second input data, to provide the propagation value.

5. The carry-lookahead adder as claimed in claim 1, wherein the logic circuit comprises:
a sixth XOR gate configured to receive the intermediate generation value and the second mask value, to provide first intermediate data;
a second AND gate configured to receive the propagation value and the second mask value, to provide second intermediate data; and
a seventh XOR gate configured to receive the first intermediate data and the second intermediate data, to provide the generation value.

6. The carry-lookahead adder as claimed in claim 1, wherein the first input data is obtained by performing a third mask operation on first data with the first mask value, and the second input data is obtained by performing a fourth mask operation on second data with the second mask value, wherein the first mask value is equal to the second mask value.

7. The carry-lookahead adder as claimed in claim 1, wherein the first input data is obtained by performing a third mask operation on first data with the first mask value, and the second input data is obtained by performing a fourth mask operation on second data with the second mask value, wherein the first mask value is different from the second mask value.

8. A secure adder, comprising:
a mask generator, comprising:
a random number generator configured to randomly generate a first mask value, a second mask value and a third mask value; and
a first mask unit configured to perform a first mask operation on first data with the first mask value to obtain first masked data, and to perform a second mask operation on second data with the second mask value to obtain second masked data; and
a carry-lookahead adder, comprising:
a first exclusive-OR (XOR) gate configured to receive the first mask value and the second mask value, to provide a variable;
a second mask unit configured to perform a third mask operation on the first masked data with the variable, to obtain third masked data;
a half adder configured to receive the third masked data and the second masked data, to generate a propagation value and an intermediate generation value;
a third mask unit configured to perform a fourth mask operation on the propagation value with the third mask value, to obtain fourth masked data;
a logic circuit configured to provide a generation value according to the propagation value, the intermediate generation value and the second mask value;
a carry-lookahead generator configured to provide a carry output and a carry value according to a carry input, the generation value and the propagation value; and
a second XOR gate configured to receive the fourth masked data and the carry value, to provide a sum output.

9. The secure adder as claimed in claim 8, wherein the second mask unit comprises:
a third XOR gate configured to receive the variable and the first masked data, to provide the third masked data.

10. The secure adder as claimed in claim 8, wherein the third mask unit comprises:
a fourth XOR gate configured to receive the third mask value and the propagation value, to provide the fourth masked data.

11. The secure adder as claimed in claim 8, wherein the half adder comprises:
a first AND gate configured to receive the third masked data and the second masked data, to provide the intermediate generation value; and
a fifth XOR gate configured to receive the third masked data and the second masked data, to provide the propagation value.

12. The secure adder as claimed in claim 8, wherein the logic circuit comprises:
a sixth XOR gate configured to receive the intermediate generation value and the second mask value, to provide a first intermediate data;
a second AND gate configured to receive the propagation value and the second mask value, to provide a second intermediate data; and
a seventh XOR gate configured to receive the first intermediate data and the second intermediate data, to provide the generation value.

13. The secure adder as claimed in claim 8, wherein the first mask value is equal to the second mask value.

14. The secure adder as claimed in claim 8, wherein the first mask value is different from the second mask value.

15. The secure adder as claimed in claim 8, further comprising:
a bus interface configured to provide the first data and the second data from a bus to the mask generator.

16. The secure adder as claimed in claim 15, further comprising:
a selection circuit configured to selectively provide the first mask value, the second mask value, the third mask value, the first masked data and the second masked data from the mask generator or the first mask value, the second mask value, the third mask value, the first masked data and the second masked data generated by an external circuit from the bus to the carry-lookahead generator.

17. The secure adder as claimed in claim 16, further comprising:
a storage circuit coupled between the selection circuit and the carry-lookahead adder, and configured to store the first mask value, the second mask value, the third mask value, the first masked data and the second masked data from the selection circuit.

18. A method for performing carry-lookahead addition, comprising:
obtaining a variable according to a first mask value and a second mask value;
performing a first mask operation on first input data corresponding to the first mask value with the variable, to obtain first masked data;
using a half adder to obtain an intermediate generation value and a propagation value according to the first masked data and second input data corresponding to the second mask value;
performing a second mask operation on the propagation value with a third mask value, to obtain second masked data;
providing a generation value according to the propagation value, the intermediate generation value and the second mask value;
using a carry-lookahead generator to obtain a carry output and a carry value according to a carry input, the generation value and the propagation value; and
obtaining a sum output according to the second masked data and the carry value,
wherein the first mask operation and the second mask operation are performed by different exclusive-OR (XOR) gates.

19. The method as claimed in claim 18, further comprising:
performing a third mask operation on first data with the first mask value, to obtain the first input data; and
performing a fourth mask operation on second data with the second mask value, to obtain the second input data.

20. The method as claimed in claim 18, further comprising:
generating the first mask value, the second mask value and the third mask value with a random number generator.
